(19) United States
(12) Patent Application Publication
(10) Pub. No.: US 2026/0358797 A1
(43) Pub. Date: Nov. 12, 2026

(54) Tool-Carrying Demolition Robot With Intelligent Control System and a Way to Control a Machine Subsystem That is Part of the Demolition Robot

(71) Applicant: BROKK AKTIEBOLAG, Skellefteå (SE)

(72) Inventor: Johan Grahn, Skelleftehamn (SE)

(21) Appl. No.: 19/121,767

(22) PCT Filed: Oct. 16, 2023
(86) PCT No.: PCT/SE2023/051025

§ 371 Date: Apr. 16, 2025

(30) Foreign Application Priority Data
Oct. 25, 2022 (SE) 2251239-6

(51) Int. Cl. G05D 1/222; B02C 25/00; G05D 101/00; G05D 105/05; G05D 107/90; G05D 109/10; G05D 111/30; H04W 4/40; H04W 4/80

(52) U.S. Cl. CPC G05D 1/222; B02C 25/00; H04W 4/40; H04W 4/80; G05D 2101/22; G05D 2105/05; G05D 2107/90; G05D 2109/10; G05D 2111/30

(57) ABSTRACT

A demolition robot including a movable arm that is connectable to a tool. The tool can include an electronic data storage device with identification data of the tool, and the moving arm can include a sensor to detect sensing the presence of the tool. The demolition robot can include a controller able to receive the identification data from the electronic data storage device of the tool as well as working data usable by the controller to affect operation of the demolition robot in accordance with a control parameter associated with the tool. The controller can receive the working data from a cloud computing service or from the tool's electronic data storage device, among other possibilities.

### TECHNICAL FIELD

The present invention relates to a tool-carrying demolition robot with intelligence for adjusting the operating characteristics of at least one machine subsystem included in it according to the preamble to claim 1. The invention also relates to a way of controlling the operating characteristics of a machine subsystem of a tool-carrying demolition robot according to the preamble to claim 12. The invention also relates to a tool intended to be carried by a demolition robot according to claim 17.

### BACKGROUND

A demolition robot is a tool-carrying robot vehicle that is normally remotely controlled by an operator who walks next to the demolition robot and remotely controls it by means of a remote control device, i.e. essentially a portable communication device that is supported on the operator's body via a harness or the like.

A demolition robot typically has a lower carriage with a propulsion unit that can include tracks and an upper carriage rotatable on said lower carriage in a horizontal plane with a manoeuvrable arm that at its free end has a tool attachment, a so-called quick attachment by means of which the demolition robot can switch between carrying different types of tools. The tool that the demolition robot currently carries, such as a hydraulic hammer, concrete cutter, saw or the like, depends on the actual application or task of the demolition robot. The work is normally carried out through a combination of different operations, which can be, for example, crushing or chiselling of concrete with a hydraulic hammer, cutting steel reinforcement with concrete cutter and removing loose building materials with a scooping tool.

Each of the various tools that the demolition robot is designed to carry normally has different operating characteristics and thus imposes different requirements on various machine subsystems of the demolition robot. The hydraulic system of the demolition robot is very much such a machine or operating subsystem, whose current operating parameters affect how efficiently a tool attached to the arm can work because not only do different tools have varying operating needs, but also similar tools of different brands can normally exhibit varying operating needs.

As an example, a tool in the form of a hydraulic hammer or a saw normally requires large hydraulic fluid flows (l/min) to drive a power-demanding hydraulic motor that the current user is equipped with, while, for example, a concrete cutter normally requires the opposite in that the concrete cutter has relatively little hydraulic flow requirement to drive its working hydraulic cylinder but requires high hydraulic pressure.

Storing predetermined working data with control parameters adjusted to the operation of a limited number of different standard tools in a fixed memory of the demolition robot is a known procedure. By means of a regulator in the form of a microprocessor, the operating characteristics of the operating subsystems included in the hydraulic system of the demolition robot can be manually manipulated through the appropriate programming by the operator so that the associated operating subsystem is adjusted to the current one in the arm attached to the standard tool.

Usually said programming is done by the operator via a user interface on the remote control device, for example in the form of menus with graphic symbols representing various standard tools such as a hammer or a saw. The adjustment of the operating characteristics is limited in that the operator can only specify the general type of tool currently attached to the arm. It should be understood that the term “attached” means in this context that the tool is supported so as to be kept, secured or locked in the holder of the arm.

Based on the operator's choice from the various menus of the portable remote control device, the appropriate operating mode is selected by the controller receiving predetermined control and limiting parameters from the memory depending on the tool type selected by the operator. If the operator has not made any tool selection and thus the appropriate operating mode is missing, the system automatically selects stored default operating characteristic parameters.

A disadvantage of controlling the operating characteristics of operating subsystems with the systems known so far is not only that the programming operation itself involves a cumbersome and disturbing operation of the operator, but also that the predetermined control parameters stored in the memory for the operation of various types of tools are, in practice, rough generalized estimates that do not necessarily correspond to reality, much less to the preferred or optimal operating parameters of the tool in question.

Although known systems often make it possible for an operator to manually choose or adjust certain control parameters via user interfaces such as menus, controls or similar means of control, such manual adjustment is an unnecessary, time-consuming task that often places great demands on the operator's knowledge and experience. In addition, it should be noted that the operating needs may differ significantly not only between different types of tools, but also between the same type of tools depending on both the actual dimensions (weight class) of the tool and the manufacturer.

It is thus desirable to provide a demolition robot that makes it possible to adjust in a simpler and more efficient manner the operating parameters of one or more of the many operating subsystems that are part of a demolition robot depending on the actual operating needs of the tool in question.

### INVENTION SUMMARY

Therefore, the first goal of the present invention is to create an intelligent demolition robot, which can automatically adjust the operating characteristics of at least one machine subsystem included in it according to the operating needs of the tools the demolition robot carries. The second goal of the invention is to provide a way of controlling the operating characteristics of a machine subsystem of a demolition robot depending on each choice of tool of the demolition robot. The third goal of the invention is to suggest a tool intended to be carried by a demolition robot according to the invention.

These goals of the invention are achieved by a demolition robot tool system exhibiting the features and characteristics set forth in claim 1, a way of controlling the operating characteristics of a machine subsystem of a demolition robot set forth in claim 10, and a demolition robot tool set forth in claim 14. Other features and characteristics of the invention are stated in the subclaims.

According to one embodiment, a demolition robot tool system includes
a demolition robot and a tool which are interchangeably attached to the demolition robot's movable arm,
an operating subsystem which includes a control unit with nominal working data WDnom for the demolition robot,
an electronic data storage device with identification data ID of the tool,
a sensor configured to sense the presence of the tool,
a controller configured via a communication interface to receive said identification data ID from the electronic data storage device of the tool, wherein the controller is configured to identify the attached tool and perform at least one of the following operations:
a) to establish a connection to a cloud service through said communication interface;
to receive the preferred working data WDpref for the identified tool from the cloud service and, with the guidance of the preferred working data, manipulate the control signals of the control unit in the operating subsystem;
b) to establish a connection to the electronic data storage device of the tool, through said communication interface;
to receive the preferred working data (WDpref) for the identified tool from the tool's electronic data storage device and, guided by the preferred working data, manipulate the control signals of the control unit in the operating subsystem;
c) to establish a connection to the tool's electronic data storage device through said communication interface;
to receive via an input channel of a remote control device included in the demolition robot the preferred working data (WDpref) of the identified tool specified by an operator and manipulate the control signals of the control unit in the operating subsystem with the guidance of the preferred working data.

According to another embodiment, the data storage device, for example in the form of an RFID tag, is assigned a unique ID number which controls in which record or location information about the preferred working data WDpref of the tool is stored, i.e. whether the preferred working data WDpref is stored immediately in the electronic data storage device of the tool or if the preferred working data WDpref is stored in a cloud service.

According to one embodiment, the controller is configured to receive preferred working data WDpref from the electronic data storage device of the tool or from the cloud service based on location information in the data storage device identification data (ID).

### DESCRIPTION OF DRAWINGS

Below the invention is described in more detail using an embodiment example shown in the attached drawings, where:

FIG. 1 schematically shows a demolition robot operated and controlled by an operator walking next to the machine and how the demolition robot can be assigned preferred working data from a data storage device on a tool or from a cloud service;

FIG. 2a shows an example of marking data on hydraulic hammers in the first embodiment with relatively low working weight;

FIG. 2b shows an example of marking data on a hydraulic hammer in the second embodiment with working weight relatively higher than that of the hydraulic hammer in FIG. 2a;

FIG. 3 schematically shows a block diagram of a control system for controlling different operating characteristics of at least one operating subsystem of the demolition robot according to the present invention;

FIG. 4 shows a flowchart regarding a way, in the first embodiment, to adjust at least one machine subsystem included in a demolition robot according to the invention,

FIG. 5 shows a flowchart regarding a way to provide, in the second embodiment, adjustment of at least one machine subsystem included in a demolition robot according to the invention.

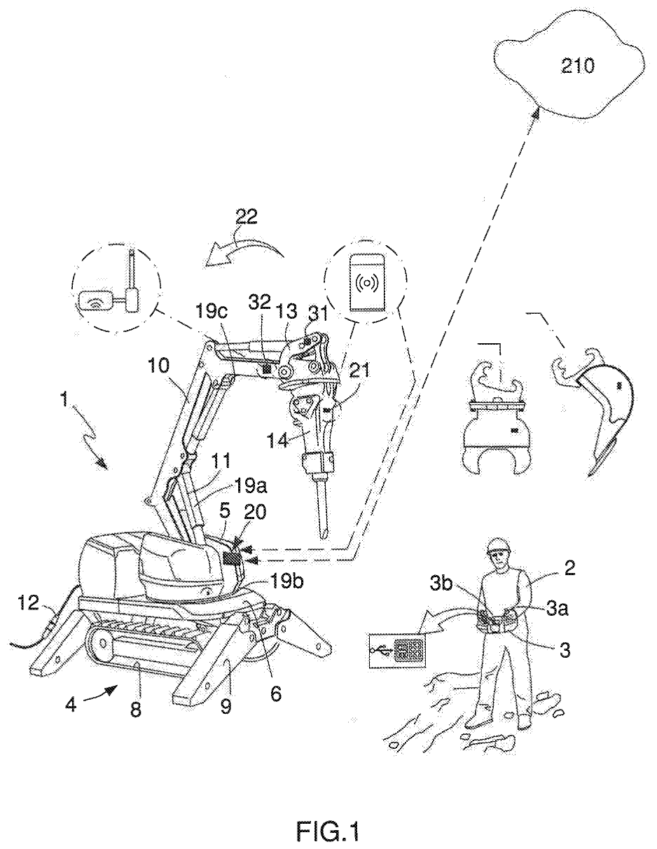

Referring to FIG. 1, a demolition robot tool system is shown which includes a demolition robot 1 with a device for controlling the operating characteristics of at least one of many different operating subsystems included in the demolition robot depending on a current tool selection. Below the term operating subsystem or machine subsystem refers to each of the different systems that have the task of using control units (microcomputers) to control and diagnose different parts of a demolition robot electronically.

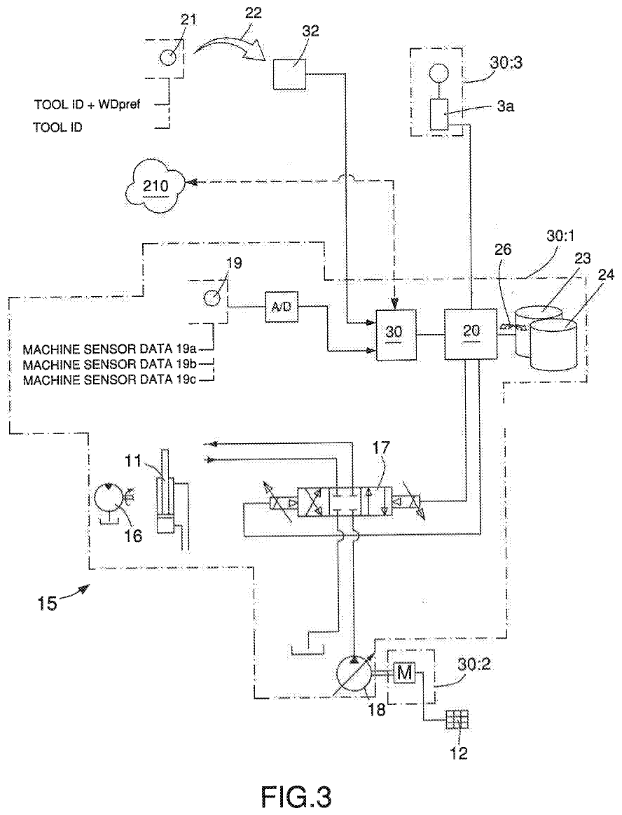

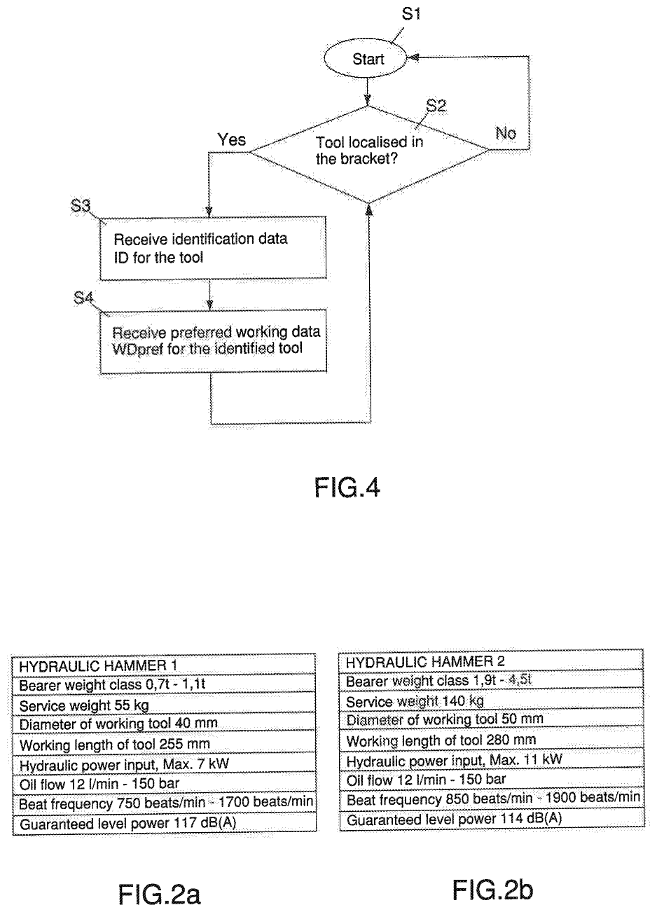

In FIG. 2, by way of example, the dash-dotted contour line shows some of the large number of ‘n’ subsystems 30:1, 30:2, 30:3 included in a demolition robot 1, the operating characteristics of which will be varied to present examples in accordance with the present invention.

Below the invention is described essentially only from the point of view of the hydraulic operating subsystem of the demolition robot and how the invention is applied to it. However, it should be understood that the invention is applicable to the control of operating parameters of each n-th operating subsystem 30:1-30 included in a demolition robot. However, each of the three operating subsystems listed below will be described below:
the first operating subsystem 30:1 comprising a hydraulic system;
the second operating subsystem 30:2 comprising an electric motor control system;
the third operating subsystem 30:3 comprising an operator manoeuvring system.

As an introduction, it should also be mentioned that in a hydraulic system, selected operating parameters may refer to flow-pressure limitations, limitation of the permissible range of movement of hydraulic flow consumers for tools, etc. In an electric motor control system, selected operating parameters may include dynamic control of the electric motor to meet the power requirements of the hydraulic system, speed control, for example, to provide noise reduction for tools with low power requirements, electric current limitation control; and in an operator manoeuvring system, selected operating parameters may refer to the selection of joystick functions, steering wheel button functions adjusted to the tool in question, etc. Furthermore, it may be mentioned that control units included in each operating subsystem may form one or more computer networks at different levels and are usually of CAN bus type or the like.

Again with reference to FIG. 1, it is shown how an operator 2 walks next to the demolition robot 1 and remotely controls it, wirelessly via a remote control device 3. A chassis with a trolley that comprises an upper carriage 5 and a lower carriage 6 is generally denoted by 4. The upper carriage 5 is pivotally supported on the lower carriage 6 for pivoting in a horizontal plane around a vertical axis. The lower carriage 6 is provided with a propulsion device comprising the right and left tracks 8. Outriggers operated by associated hydraulic cylinders are denoted by 9 and a manoeuvrable arm supported on the upper carriage 5 and manoeuvrable by means of hydraulic cylinders 11 is denoted by 10. The above hydraulic components form part of the above said first operating subsystem 30:1, which comprises the demolition robot hydraulic system.

A cable intended to be connected to a stationary electric grid to supply electrical power to the demolition robot 1 is denoted by 12. In addition to a variety of motor control electronics (not shown), said cable 12 forms part of the above-mentioned second operating subsystem 30:2, which includes the electric motor control system of the demolition robot 1.

Arm 10 is provided at its free end with a tool attachment 13 in which different types of tools 14, such as a hydraulic hammer, a hydraulic cutter and a bucket, can be interchangeably attached and, if needed, also connected for hydraulic operation. Said tool 14 is included in the present demolition robot tool system. Said hydraulic hammers, saws and hydraulic cutters, respectively, constitute such typical hydraulically driven tools 14, whose function can be operated and controlled by the remote control device 3.

The remote control device 3 includes joysticks 3a, buttons and similar means that can be actuated by operator 2 to operate and control various functions of the demolition robot. Operator 2 can set up the demolition robot 1 in different driving settings, so-called modes, via the remote control device 3. Depending on the selected driving mode, the joysticks 3a and other controls will control different functions of the demolition robot. Some examples of such driving modes are “Driving function lower carriage” and “Driving function arm system” in which the demolition robot can be operated and controlled by the action of the joysticks. Selected driving mode can be displayed using symbols on a user interface of the remote control device 3. The above-mentioned levers and controls thus form part of the above-mentioned third operating subsystem 30:3, which comprises an operator manoeuvring system.

For better understanding of the invention, FIG. 2a and FIG. 2b show examples of how marking data and thus also preferred working data can differ significantly between two known hydraulic hammers of the same brand, but of different weight classes.

Some of the main components included in a hydraulic system 15 of the demolition robot 1 are shown schematically in FIG. 3. The hydraulic system 15 comprises multiple hydraulic flow consumers in which the above said hydraulic cylinder 11 of the arm 10 constitutes one of the multiple hydraulic motors 16, among which an external hydraulic motor can constitute a driving unit for a tool (hydraulic hammer, saw), while other internal hydraulic motors included in the demolition robot are normally used to drive the demolition robot's tracks 8 and to rotate the upper carriage 5 in relation to lower carriage 6. The hydraulic system 15 further includes an electronically controlled proportional type hydraulic valve 17 located between a hydraulic pump 18 and each of said consumers.

Referring again to FIG. 1, it is shown how the hydraulic system 15 can include a number of sensors 19a-19c (see FIG. 3) among which can be mentioned a length sensor 19a for sensing the longitudinal displacement of each hydraulic cylinder 11, an angle/speed sensor 19b that senses the turning movements of a hydraulic motor and thus should be used to determine the relative angular position of the upper carriage 5 and thus also arm 10 in a horizontal plane relative to the lower carriage 6. The hydraulic system 15 may also include angle sensors 19c arranged for sensing a relative angular position of different arm parts included in the arm 10. Based on information from said sensors 19a-19c, i.e. in the present example length sensor 19a and angle sensors 19b, 19c, for example, for autonomous driving, both the position of a tool 14 and the speed of movement in a coordinate system in a three-dimensional space (3D space) can be calculated, which can also be used to operate and control a tool to move along a path in a predetermined route or to check that a tool is within a work area permitted for the tool and/or does not exceed a predetermined speed of movement. As mentioned above, the remote control device 3 includes joysticks 3a, buttons and steering wheels that can be actuated by the operator 2 to operate and control various functions of the demolition robot 1. Via the electronic hydraulic valve 17, the function of the various consumers and thus the movements of the demolition robot as a whole are controlled. A controller 30 for controlling the hydraulic valve 17 based on a signal from the control switch 3a for conveying a control order to the control unit 30, whereby the unit is designed to control the hydraulic valve 17 according to predetermined functions stored in a data storage device 23 belonging to the control unit 30.

In FIG. 1, number 31 denotes a tool sensor device configured to sense the presence of a tool 14 attached to the arm. The tool sensor device 31 may in its simplest form consist of a mechanical switch which is actuated by the attached tool 14 when the bracket is in its locking position but is advantageously selected from among any of the known sensors that allow non-contact presence detection, for example, the type that uses radio waves or light to sense the presence and location of a tool 14 in the bracket 13.

The demolition robot 1 also includes a tool reading device 32 that includes a communication interface 22, which can be set into communication with the electronic data storage device 21 of the tool 14 to retrieve the identification data ID and preferred working data WDpref of the tool 14 attached to the arm 10. The tool reading device 32 is enabled to read data from the data storage device 21 on the tool 14 upon receipt of a signal from the tool sensor device 31 that tool 14 is located in the bracket 13 of the arm member 10. The tool reading device 32 suitably includes a device for short-range data communication that uses radio waves within the license-free area such as near field communication (NFC) or Bluetooth communication (BLE). The tool reading device 32 can also be of the so-called RFID type (Radio-frequency identification), which can read from transponders and memories at a distance, so-called RFID tags. These RFID tags include a unique ID number and, if they are of the so-called passive type, can normally transmit a few decimetres without their own power source. An RFID transponder has all the information stored in a database. The record or location where the information is stored is normally tied to the unique ID number of the RFID transponder. Where the record is stored can thus be controlled by the unique ID number of the RFID transponder.

In an embodiment where the electronic data storage device 21 of the tool 14 includes both the identification data ID and the preferred working data of the tool WDpref, an active or semi-passive RFID tag may be used whereby said combination of data may be read by the tool reading device 32.

In an alternative embodiment of the invention, the demolition robot system is designed to establish a connection to a cloud service 210 through said communication interface 22, and to receive preferred working data WDpref of the identified tool from the cloud service 210 and, guided by preferred working data, manipulate the control signals of the control unit 20 in the operating subsystem 30:1. A unique ID number of the RFID tag can conveniently be used to indicate that information about the record with preferred work data WDpref for a current tool 14 is stored in the cloud service 210.

The demolition robot 1 may suitably be equipped with a wireless communication interface 22 to communicate with the cloud service 210 directly or indirectly by communicating via another device, such as a server, a personal computer or smartphone. Examples of such wireless communication devices are Wifi® (IEEE 802.1 lb), Bluetooth®, Global System Mobile (GSM) and LTE (Long Term Evolution), to name a few. Where applicable, the controller 30 is configured to receive preferred working data WDpref from the cloud service 210 based on location information in the identification data ID of the data storage device 21.

The device according to the invention operates to enable effective adjustment or limitation of at least one operating parameter of at least one of many operating subsystems 30:1-30:n included in the demolition robot 1. The electronic tool data storage device 31 with which each tool 14 is equipped includes the identification data ID of the tool and the preferred working data WDpref of the tool 14 where said preferred working data includes data for controlling at least one operating parameter OP of at least one operating subsystem 30:1 included in the demolition robot.

In an alternative embodiment, it is conceivable that the cloud service 210 is configured to collect operating settings of the parameter-adjusted nominal working data WDnom of the operating subsystem 30:1 and to transmit this collected data along with the identification data ID of the tool 14 and a log storage task for the collected data to the cloud service 210. Since it is possible to collect at the point of use tool-specific settings for different tools 14 during operation and to transfer such collected data to the cloud 210 along with a log storage task, the material becomes searchable and usable for, for example, machine manufacturers in the follow-up, tracking and tool and/or machine development or to provide an owner of a fleet of demolition robot machines with desirable information about the operating conditions of the machines.

The operating information included in the preferred working data WDpref stored and readable on each tool 14:1-14:n can include predetermined operating values for the specific tool 14 such as the tool's unladen weight, working length or other characteristics that are limiting the tool's movement in space to avoid collision and the risk of the demolition robot tipping as a result of an unfortunate movement of the centre of gravity due to the weight of the tool.

As described above, the demolition robot 1 includes at least one operating subsystem 30:1, where each of such operating subsystems includes a control unit 20 comprising nominal working data WDnom stored in a data storage device 23 for controlling various functions of the operating subsystem. Tool 14 is further normally attached to the arm 10 of the demolition robot 1. Below, the term nominal value refers to the work data or parameters declared by the manufacturer of the equipment. Also compare the term marking data which in the context can be considered substantially equivalent to the term nominal value as used here.

Electronic data storage device 21 is associated with the tool 14, such device having a unit for storing data comprising identification data ID of the tool a sensor device 31 arranged on the arm 10 is configured to sense the presence of the tool 14 attached to the arm 10, a controller 30 which via a communication interface 22 is configured to retrieve said identification data ID from the electronic data storage device 21 of the attached tool, wherein the controller 30 is further configured to identify the attached tool 14.

The controller 30 is configured via said communication interface 22 to receive said identification data ID from the electronic data storage device 21 of the tool 14, wherein the controller 30 is configured to identify the attached tool 14 and perform at least one of the following operations:
a) to establish a connection to a cloud service 210 through said communication interface 22;
to receive the preferred working data WDpref of the identified tool from the cloud service 210 and, guided by the preferred working data, manipulate the control signals of the control unit 20 in the operating subsystem 30:1;
b) to establish a connection to the electronic data storage device 21 of the tool, through said communication interface 22;
to receive the preferred working data WDpref of the identified tool 14 from the tool electronic data storage device 21 and, guided by the preferred working data, manipulate the control signals of the control unit 20 in the operating subsystem 30:1.

The controller 30 may be configured to provide manipulated control of the operating subsystem 30:1 by replacing at least one nominal operating parameter OPnom included in the operating subsystem 30:1 or by parameter-adjusting at least one nominal operating parameter OPnom of the operating subsystem 30:1.

According to the invention, the term manipulated refers to any type of distortion, parameter adjustment or exchange of one or more operating parameters OP of the nominal working data WDnom included in a control unit 20 of each operating subsystem of a demolition robot.

The controller 30 is configured to provide manipulated control of at least one operating subsystem 30:1 using the preferred working data WDpref from the data storage device 21 of the tool 14, i.e., the controller 30 is configured to identify the attached tool 14 and using the preferred working data WDpref, manipulate the control signals of the controller 20 in the operating subsystem 30:1. In one embodiment of the invention, the controller 30 may be configured to manipulate the operating subsystem 30:1 to control each operating parameter OP of the operating subsystem based on preferred working data (WDpref).

In an alternative embodiment of the invention, the demolition robot 1 may include a first data storage device 23 containing nominal working data WDnom representative of an allowable range for controlling at least one nominal operating parameter OPnom in at least one operating subsystem 30:1, a second data storage device 24 containing preferred working data WDpref received from the attached tool 14 for controlling at least one preferred operating parameter OPpref in at least one operating subsystem 30:1, a data interface 26 for communication between the controller 30 and said respective data storage devices 23, 24 and comparison of the preferred working data WDpref with the allowable range of nominal working data WDnom, wherein if the value of at least one said preferred operating parameter OPpref of the preferred working data WDpref is within the allowable range, the operating parameter is selected from said preferred working data WDpref for controlling the operating subsystem 30:1, and if the value of at least one said preferred operating parameter OPpref of the preferred working data WDpref is outside the allowable range, nominal working data WDnom is selected for controlling the operating subsystem 30:1.

The operating subsystems 30:1 controlled in a manipulated manner by the controller 30 may comprise at least one of the following: a hydraulic subsystem, a subsystem for self-controlled or autonomous operation of the travel path of the tool 14 along a predetermined route in a three-dimensional space.

The identification data ID of a tool 14 may include at least one of the following tool types: hammer, grapple, scissors, saw, cutter, bucket.

Preferred working data WDpref may include at least one of the following: recommended oil flow (l/min), specified tool weight (kg); recommended machine weight carrier (kg), specified tool dimensions (working tool diameter, working length of the working tool).

In one embodiment of the invention, manipulation of the control signals of the control unit 20 in the operating subsystem 30:1 may include adjustment of the control signals of the operating subsystem 30:1 with respect to the weight of the tool 14 to automatically counter deflection of the torque-loaded arm 10 during a parallel movement of the tool 14.

In another embodiment of the invention, manipulating the control signals of the control unit 20 in the operating subsystem 30:1 may include automatic limitation of the maximum travel distance of the tool 14 to avoid assigning an undesired shift of the centre of gravity to the demolition robot.

In another embodiment of the invention, manipulating the control signals of the control unit 20 in the operating subsystem 30:1 may include automatic limitation of the maximum lifting height of the tool 14.

Preferred work data WDpref may include tool weight and includes at least one of the following: adjustment of hydraulic systems when moving the tool in parallel, limitation of the maximum travel distance of the tool. In an embodiment of the invention, the preferred operating parameter OPpref may be a maximum travel distance of the tool 14.

In one embodiment, the preferred operating parameter OPpref may be a maximum height, to which the tool 14 can be lifted. In one embodiment, communication interface 22 may include any of the following means: short-range data communication technology with radio waves; near field communication (NFC); Bluetooth communication (BLE).

According to another embodiment, the demolition robot remote control device 3 may be equipped with an input device 3b with a user interface in the form of a display, graphical display device with buttons, an electronic port (USB) or similar unit that allows the input device to receive preferred working data WDpref specified by an operator of a tool 14 identified by the tool electronic data storage device 21 and, guided by preferred working data WDpref, manipulate the control signals of the control unit 20 in the operating subsystem 30:1.

FIG. 4 shows a flow diagram describing a method of the invention in the first embodiment example for adjusting at least one of the machine subsystems 30:1 contained therein. The process starts at step S1. At step S2, the presence of a tool 14 in the bracket 13 of the arm 10 is detected. If this is not the case, the system returns to the start position in step S1. From the localised tool 14 in the bracket 13, the step S3 retrieves identification data ID from the electronic data storage device 21 of the localised tool 14. At step S4, at least one preferred operating parameter OPpref from the preferred working data WDpref is selected from the tool 14 to control at least one subsystem 30:1-30:n of the demolition robot, while the operating subsystem 30:1 is controlled by the control unit 20 with signals manipulated by the controller 30 with the guidance of the received preferred working data WDpref.

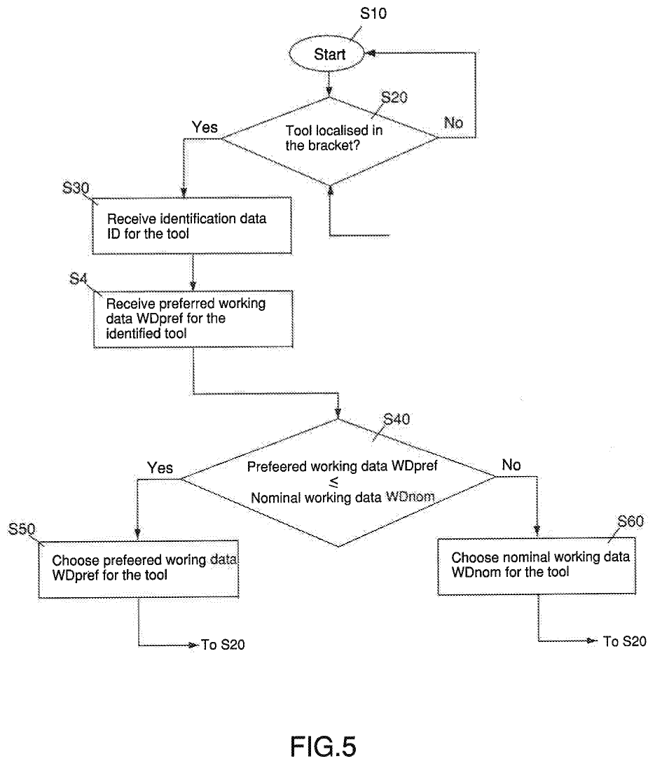

FIG. 5 shows the flowchart describing a procedure according to the invention in the second embodiment example for adjusting at least one of the machine subsystems 30:1 contained therein. The process starts at step S10. At step S20, the presence of a tool 14 in the bracket 13 of the arm 10 is detected. If this is not the case, the system returns to the start position S10. In step S30, from the localised tool 14 in bracket 13, controller 30 retrieves identification data ID from the electronic data storage device 21 of the localised tool 14. In step S40, preferred working data WDpref stored in the first data storage device 23 is compared with nominal working data WDnom stored in the second data storage device 24. If the controller in step S40 finds that the preferred working data WDpref is below or equal to the nominal working data WDnom, the preferred working data in step S50 is selected. If the controller in step S40 finds that the preferred working data WDpref is above the nominal working data, the nominal working data WDnom of the tool in step S50 is selected, while the operating subsystem 30:1 is controlled by the control unit 20 with signals manipulated by the controller 30 based on the received preferred working data WDpref.

If the tool 14 has no information about identification data ID or if the preferred work data WDpref for the tool is missing, the nominal work data WDnom is selected.

In accordance with the invention, at least one of the following operating subsystems is controlled in a manipulated way by controller 30:
the first operating subsystem 30:1 comprising a hydraulic system;
the second operating subsystem 30:2 comprising an electric motor control system;
the third operating subsystem 30:3 comprising an operator manoeuvring system.

The way of controlling an operating subsystem of a demolition robot according to the invention includes a tool 14 which is intended to be interchangeably carried in the free end of an arm 10 of the demolition robot. The tool comprises an electronic data storage device 21 in which the tool-related data comprising the identification data ID of the tool has been stored to use preferred working data WDpref either also stored together with the identification data in the data storage device 21 or retrieved from a cloud service 210 for adjusting the operating characteristics of at least one operating subsystem 13:1 of the demolition robot.

1.-17. (canceled)

18. A demolition robot, comprising:
a movable arm connectable to a tool; and
a controller configured to:
detect presence of the tool upon connection of the tool to the movable arm;
retrieve identification data associated with the tool from an electronic memory of the tool responsive to detecting the presence of the tool;
retrieve working data associated with the tool based on the identification data, the working data usable by the controller to affect operation of the demolition robot in accordance with a control parameter associated with the tool; and
affect operation of the demolition robot based on the working data.

19. The demolition robot of claim 18, wherein the controller is configured to retrieve the working data associated with the tool from the electronic memory of the tool.

20. The demolition robot of claim 18, wherein the controller is configured to retrieve the working data associated with the tool from a cloud computing service.

21. The demolition robot of claim 18, wherein the controller is configured to retrieve the working data associated with the tool from a remote control device in communication with the demolition robot.

22. The demolition robot of claim 18, wherein the controller is configured to detect the presence of the tool based on data received from a sensor located on the movable arm.

23. The demolition robot of claim 18, wherein the control parameter comprises a hydraulic flow rate, a hydraulic pressure, a hydraulic valve control parameter, or a hydraulic cylinder control parameter.

24. The demolition robot of claim 18, wherein the control parameter comprises an electric motor control parameter associated with an electric motor of the demolition robot.

25. The demolition robot of claim 18, wherein the control parameter is associated with a joystick, a button, or a display of a remote control device in communication with the demolition robot.

26. The demolition robot of claim 18, wherein the control parameter comprises a maximum travel distance associated with the tool or a maximum lifting height associated with the tool

27. A method, comprising:
detecting presence of a tool upon connection of the tool to a movable arm of a demolition robot;
retrieving identification data associated with the tool from an electronic memory of the tool responsive to detecting the presence of the tool;
retrieving working data associated with the tool based on the identification data, the working data being usable to affect operation of the demolition robot in accordance with a control parameter associated with the tool; and
affecting operation of the demolition robot based on the working data.

28. The method of claim 27, wherein retrieving the working data comprises retrieving the working data from the electronic memory of the tool.

29. The method of claim 27, wherein retrieving the working data comprises retrieving the working data from a cloud computing service.

30. The method of claim 27, wherein retrieving the working data comprises retrieving the working data from a remote control device in communication with the demolition robot.

31. The method of claim 27, wherein detecting the presence of the tool is based on data received from a sensor located on the movable arm.

32. The method of claim 27, wherein the control parameter comprises a hydraulic flow rate, a hydraulic pressure, a hydraulic valve control parameter, or a hydraulic cylinder control parameter.

33. A non-transitory computer-readable medium having instructions stored thereon that, when executed by processing circuitry, cause the processing circuitry to:
detect presence of a tool upon connection of the tool to a movable arm of a demolition robot;
retrieve identification data associated with the tool from an electronic memory of the tool responsive to detecting the presence of the tool;
retrieve working data associated with the tool based on the identification data, the working data being usable to affect operation of the demolition robot in accordance with a control parameter associated with the tool; and
affect operation of the demolition robot based on the working data.

34. The computer-readable medium of claim 33, wherein the instructions, when executed by the processing circuitry, cause the processing circuitry to retrieve the working data from the electronic memory of the tool.

35. The computer-readable medium of claim 33, wherein the instructions, when executed by the processing circuitry, cause the processing circuitry to retrieve the working data from a cloud computing service.

36. The computer-readable medium of claim 33, wherein the instructions, when executed by the processing circuitry, cause the processing circuitry to retrieve the working data from a remote control device in communication with the demolition robot.

37. The computer-readable medium of claim 33, wherein the instructions, when executed by the processing circuitry, cause the processing circuitry to detect the presence of the tool based on data received from a sensor located on the movable arm.
